(19) United States
(12) Patent Application Publication
(10) Pub. No.: US 2025/0111309 A1
(43) Pub. Date: Apr. 3, 2025

(54) ONBOARDING FOR ELECTRONIC DATA INTERCHANGE USING ARTIFICIAL INTELLIGENCE

(71) Applicant: Boomi, LP, Conshohocken, PA (US)

(72) Inventors: Michael J. Hudson, Delray Beach, FL (US); Corey Sanders, Hilliard, OH (US); Clark B. Hall, Lexington, KY (US)

(21) Appl. No.: 18/375,300

(22) Filed: Sep. 29, 2023

(51) Int. Cl. G06Q 10/0631; G06Q 10/101

(52) U.S. Cl. CPC G06Q 10/06315; G06Q 10/101

(57) ABSTRACT

Conventional onboarding for electronic data interchange (EDI) is costly, complex, and time-consuming. Accordingly, disclosed embodiments utilize artificial intelligence to provide a single, fast, streamlined EDI onboarding process. In particular, a user may converse with a generation module that queries an AI model comprising a plurality of models that may be executed in parallel. The generation module may aggregate the outputs of the plurality of models to produce EDI data, as well as collect EDI data from the user via the conversational session, until there is sufficient EDI data to generate an EDI output. The EDI output may comprise a partner profile, customer profile, communication setting(s), and/or sample electronic document(s). The EDI output may be used to construct a trading-partner element that may be incorporated into an integration process, which can be deployed and executed within an integration environment.

### BACKGROUND

### Field of the Invention

The embodiments described herein are generally directed to artificial intelligence, and, more particularly, to onboarding for Electronic Data Interchange (EDI) using artificial intelligence.

### Description of the Related Art

Electronic Data Interchange (EDI) refers to the communication, between trading partners, of business documents in a standard electronic format. Whenever an organization integrates a new trading partner into an EDI system, the organization must go through an onboarding process. This onboarding process can be costly, complex, and time-consuming. Typically, the onboarding process involves multiple manual steps, which include filling out forms, exchanging sample electronic documents, and setting up the communication channels for the electronic documents. This can take weeks, involve numerous people, and is prone to human error.

### SUMMARY

Accordingly, systems, methods, and non-transitory computer-readable media are disclosed for EDI onboarding using artificial intelligence.

In an embodiment, a method comprises using at least one hardware processor to, in each of one or more iterations of a conversational session, receive a user input; acquire an output from each of a plurality of models; aggregate the outputs of the plurality of models into electronic data interchange (EDI) data; determine whether or not the EDI data are sufficient to generate an EDI output, wherein the EDI output comprises a partner profile, a customer profile, and one or more communication settings; when the EDI data are not sufficient, generate and output a prompt, and extend the conversational session with another iteration; and when the EDI data are sufficient, generate the EDI output. The EDI output may further comprise one or more sample electronic documents to be exchanged via electronic data interchange. Each of the partner profile and the customer profile may comprise a document standard. The one or more communication settings may comprise a communication protocol.

The method may further comprise using the at least one hardware processor to, after generating the EDI output, generate an element within an integration process based on the partner profile, the customer profile, and the one or more communication settings, wherein the element comprises one or more software modules. The method may further comprise using the at least one hardware processor to deploy the integration process within an integration environment. The element may retrieve electronic documents from a partner system using the partner profile and the one or more communication settings. The element may send electronic documents to a partner system using the partner profile and the one or more communication settings.

The plurality of models may comprise a partner profile model that is trained using historical data acquired from one or more integration platforms in an integration environment. The historical data may comprise customer and partner profiles implemented in the one or more integration platforms and EDI transactions that have occurred in the one or more integration platforms. The integration environment may be an integration platform as a service (iPaaS) platform. The partner profile model may comprise an artificial neural network. The partner profile model may be trained to predict one or more output features, each representing a parameter of the partner profile, based on one or more input features.

The plurality of models may comprise a market profile model that is trained on unstructured data. The unstructured data may comprise websites. The market profile model may comprise a large language model.

The plurality of models may comprise a customer profile model that is trained using one or both of structured or semi-structured data. The structured or semi-structured data may comprise electronic documents.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the processes described herein may be implemented, according to an embodiment;

FIG. 2 illustrates an architecture for EDI onboarding using artificial intelligence, according to an embodiment;

FIG. 3 illustrates an example screen of a user interface for EDI onboarding using artificial intelligence, according to an embodiment;

FIG. 4 illustrates an example process for EDI onboarding using artificial intelligence, according to an embodiment; and

FIG. 5 illustrates an example processing system, by which one or more of the processes described herein may be executed, according to an embodiment.

### DETAILED DESCRIPTION

In an embodiment, systems, methods, and non-transitory computer-readable media are disclosed for EDI onboarding using artificial intelligence (AI), such as machine learning (NIL). After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

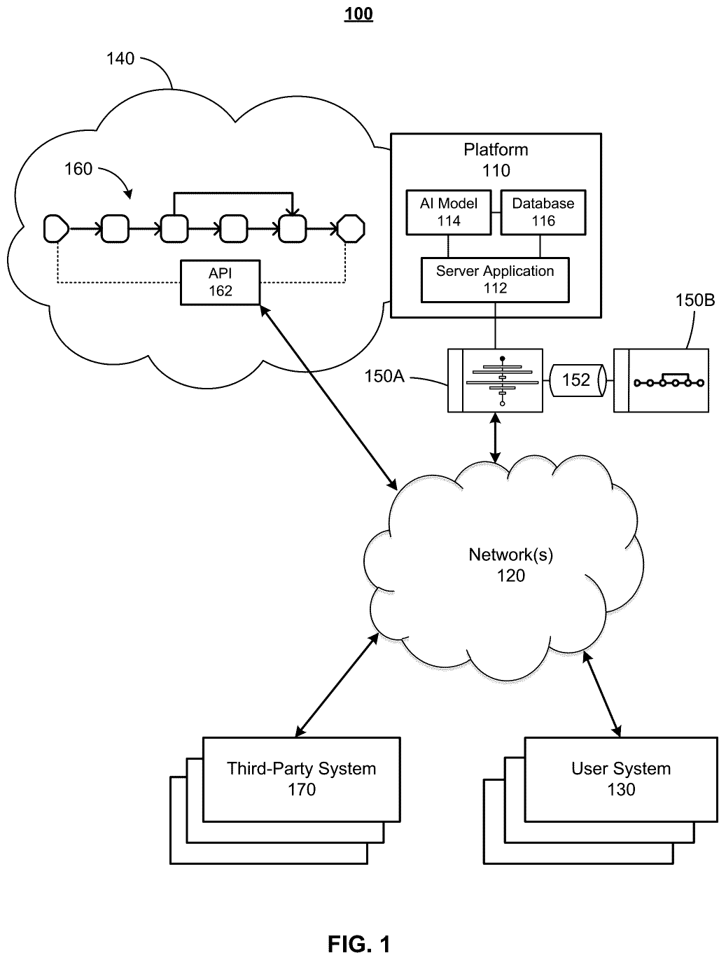

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110.

Server application 112 may manage an integration environment 140. In particular, server application 112 may provide a user interface 150 (e.g., illustrated as screens 150A and 150B) and backend functionality, including one or more of the processes disclosed herein, to enable users, via user systems 130, to construct, develop, modify, save, delete, test, deploy, un-deploy, and/or otherwise manage integration processes 160 within integration environment 140.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or more integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” or “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including analyzing, normalizing, altering, updated, enhancing, and/or augmenting the received data), and send the manipulated data to one or more specified destinations. An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

Of particular relevance to the present disclosure, the backend functionality of server application 112 may include a process for EDI onboarding using an AI model 114. A user may utilize one or more first screens 150A of user interface 150, generated by server application 112, to interact with AI model 114. Server application 112 may drive a conversational session with a user, for example, through a chat interface in first screen 150A. The chat interface may comprise a graphical user interface, in which case, the user may input text, and server application 112 may output text. Alternatively or additionally, the chat interface may comprise an audio or audiovisual user interface, in which case, the user may input speech, which server application 112 may convert to text via a suitable speech-to-text engine, and server application 112 may output synthesized speech via a suitable text-to-speech engine. Platform 110 may also manage a database 116, which may store data used by server application 112 and/or AI model 114.

Over each conversational session, server application 112 collects EDI data from the user and/or AI model 114. Once sufficient EDI data have been collected, server application 112 generates an EDI output 152. EDI output 152 may comprise a partner profile, a customer profile, one or more communication settings, and/or one or more sample electronic documents. EDI output 152 may be used to generate a trading-partner element, within an integration processes 160, which may implement an electronic data interchange between a customer (e.g., the organization represented by the user) and a trading partner (e.g., another organization that exchanges business documents with the customer). Integration process 160, along with the generated element, may be constructed within one or more second screens 150B of graphical user interface 150. The user may construct, configure, and/or finalize integration process 160 within second screen 150B, and then deploy the final integration process 160 to integration environment 140.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162 and/or pull data from integration process 160 through application programming interface 162.

One or more third-party systems 170 may be communicatively connected to network(s) 120, such that each third-party system 170 may communicate with an integration process 160 in integration environment 150 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. Of particular relevance to the present disclosure, third-party system 170 may represent a trading partner. As examples, the software application on third-party system 170 may comprise, without limitation, enterprise resource planning (ERP) software, customer relationship management (CRM) software, accounting software, and/or the like.

### 2. Example Architecture

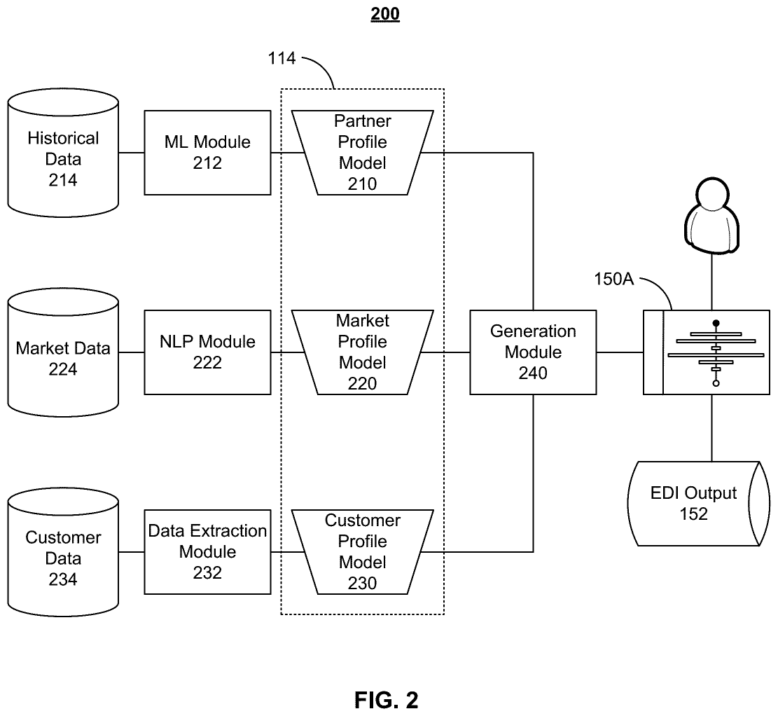

FIG. 2 illustrates an architecture 200 for EDI onboarding using artificial intelligence, according to an embodiment. Architecture 200 comprises an AI model 114, which includes a plurality of models, including a partner profile model 210, a market profile model 220, and/or a customer profile model 230. In addition, architecture 200 comprises a generation module 240 that drives a conversational session within first screen 150A of user interface 150. Generation module 240 aggregates the outputs of the plurality of models 210, 220, and 230 in AI model 114 into EDI data, collects additional EDI data from the user, and/or generates EDI output 152 based on the collected EDI data. Generation module 240 may be implemented in server application 112.

Partner profile model 210 may be trained by a machine-learning (ML) module 212 based on historical data 214. Historical data 214 may comprise actual implemented trading-partner profiles (e.g., customer and/or partner profiles) and actual EDI transactions that have occurred within integration environment 140. In an embodiment in which integration environment 140 provides iPaaS, there may be voluminous historical data 214 across a wide range of customers, trading partners, types of documents, markets or industries, and/or the like. In addition, such historical data 214 may comprise both sides of EDI transactions. All or a representative subset of this historical data 214 may be used to train partner profile model 210. From historical data 214 and via ML module 212, partner profile model 210 may learn patterns and relationships between different trading partners, including how to predict output features such as, but not limited to, electronic identifiers, document standards, versions of document standards, technical specifications, configuration information (e.g., functional acknowledgements, document validation, control numbers, etc.), contact information, communication settings, and/or the like. Thus, when provided with a query, comprising one or more input features, partner profile model 210 may return a relevant set of one or more output features.

In an embodiment, partner profile model 210 may be a deep-learning artificial neural network. In this case, partner profile model 210 may be trained using supervised learning. In particular, the training dataset, which may be derived from historical data 214, may comprise a plurality of records that each include one or more input features labeled with one or more target output features. The artificial neural network may be trained to, for each of the plurality of records, minimize a loss function between the target output feature(s) and the actual output feature(s) of the artificial neural network when provided the input feature(s) from the record. The input feature(s) may represent known value(s) in a partner profile, metadata of the partner profile, and/or other information related to the partner profile, whereas the target feature(s) may represent ground-truth value(s) in the partner profile and/or communication setting(s) and the actual output feature(s) may represent predicted value(s) in the partner profile and/or communication setting(s). Alternatively, partner profile model 210 may be another type of model and/or be trained using unsupervised learning. Regardless of how partner profile model 210 is implemented, the output feature(s) may represent value(s) of parameter(s) comprised in, or otherwise relevant to, a partner profile and/or communication setting(s) for a trading partner.

Market profile model 220 may be trained by a natural language processing (NLP) module 222 based on market data 224. Market data 224 may comprise unstructured data, such as one or more webpages of one or more, and generally a plurality of, websites. These websites may comprise data sources that are relevant to markets that utilize electronic data interchange. Examples of such websites include, without limitation, knowledge repositories, such as Wikipedia™ or other online encyclopedias, dictionaries, and/or the like, corporate websites for various companies, news websites, journal websites, and/or the like. NLP module 222 may crawl relevant websites and extract information from the webpage(s) of the website that is relevant to markets that utilize electronic data interchange. From market data 224 and via NLP module 222, market profile model 220 may learn organizational information and relationships between organizations. The organizational information may comprise identifying information (e.g., company name, mailing address, website address, telephone number, etc.), firmographic information (e.g., markets or industries in which the company participates, etc.), and/or the like. Thus, when provided with a query (e.g., a set of one or more keywords), market profile model 220 may return a subset of such information that is relevant to that query.

In an embodiment, market profile model 220 comprises a generative AI model, such as the generative pre-trained transformer (GPT) series of large language models, offered by OpenAI, L.P. of San Francisco, California. The latest in the GPT series is the GPT-4 model, but it should be understood that any past or future models in the GPT series could also be used. Market profile model 220 may receive a prompt from generation module 240. The prompt may be a query for information, and market profile model 220 may return a response to the prompt, representing an answer to the query.

Customer profile model 230 may be trained by a data extraction module 232 based on customer data 234. Customer data 234 may comprise semi-structured and/or structured data (e.g., documents), such as spreadsheets, web forms, email messages, notes, and/or the like. From customer data 234 and via data extraction module 232, customer profile model 230 may learn patterns used by organization(s) that perform EDI onboarding on platform 110, including information such as, but not limited to, electronic identifiers, document standards, versions of document standards, technical specifications, configuration information (e.g., functional acknowledgements, document validation, control numbers, etc.), contact information, communication settings, and/or the like, utilized by the customer(s).

In an embodiment, customer profile model 230 may be similar to partner profile model 210. In particular, customer profile model 230 may comprise a deep-learning artificial neural network. In this case, customer profile model 230 may be trained using supervised learning. In particular, the training dataset may comprise a plurality of records that each include one or more input features labeled with one or more target output features. The artificial neural network may be trained to, for each of the plurality of records, minimize a loss function between the target output feature(s) and the actual output feature(s) of the artificial neural network when provided the input feature(s) from the record. The input feature(s) may represent known value(s) in a customer profile, metadata of the customer profile, and/or other information related to the customer profile, whereas the target feature(s) may represent ground-truth values in the customer profile and/or communication setting(s) and the actual output feature(s) may represent predicted value(s) in the customer profile and/or communication setting(s).

Alternatively, customer profile model 230 may be another type of model and/or be trained using unsupervised learning. For example, customer data 234, representing a plurality of data sources, may be clustered (e.g., using a clustering method) or associated (e.g., using an association rule) into groups according to similarities and differences between the data sources. Any suitable unsupervised learning algorithm may be used, including, without limitation, k-means clustering, k-nearest neighbors (KNN), hierarchical clustering, anomaly detection, artificial neural networks, principle component analysis, independent component analysis, the a priori algorithm, singular value decomposition, and/or the like. Once the data sources have been clustered into groups, each group of data sources may be associated with a context, which may be used to index the data sources for retrieval in response to queries from generation module 240. In particular, the generation module 240 may send queries, comprising one or more input features, and customer profile model 230 may return one or more output features. The input feature(s) may represent known value(s) in a customer profile, whereas the output feature(s) may represent predicted value(s) in the customer profile and/or communication setting(s).

Generation module 240 collects EDI data by aggregating the outputs of partner profile model 210, market profile model 220, and customer profile model 230, along with user inputs provided through the chat interface in first screen 150A. In particular, generation module 240 automatically walks the user through a series of steps to collect, as the EDI data, all of the information needed to produce EDI output 152. EDI output 152 may comprise a partner profile, a customer profile, one or more communication settings, and/or one or more sample electronic documents.

The partner profile may represent a trading partner with the organization (i.e., customer) utilizing platform 110, and comprise the document standard (e.g., including the version of the document standard if applicable) used by the trading partner. The document standard may include the document types and file options that satisfy the specification(s) defined by the trading partner. Examples of document standards include, without limitation, the Accredited Standards Committee (ASC) X12 EDI standard, Health Level 7 (HL7) standard, RosettaNet standard, United Nations rules for Electronic Data Interchange for Administration, Commerce and Transport (UN/EDIFACT) standard, Tradacoms standard, and Organization for Data Exchange by Tele Transmission in Europe (ODETTE) EDI standard. In an electronic data interchange that involves multiple trading partners, a partner profile may be generated for each trading partner.

The customer profile may represent the customer, and comprise the document standard used by the customer. In other words, the customer profile may be similar or identical to the partner profile, but represent the customer's side of the electronic data interchange. It should be understood that the customer profile may not necessarily need to be recreated in every conversational session, since the customer profile may be the same across a plurality of trading partners of the customer, and therefore, may already exist. In this case, generation module 240 may retrieve an existing customer profile from memory, instead of regenerating the customer profile. Alternatively, EDI output 152 may comprise a newly generated customer profile.

The communication setting(s) may comprise the communication method used to send and retrieve electronic documents between the customer and the trading partner. Examples of communication methods include, without limitation, Applicability Statement 2 (AS2), FTP, HTTP, SFTP, Minimal Lower Layer Protocol (MLLP), a disk method in which a connection directory is identified for reading and writing files, and/or the like.

The sample electronic document(s) are samples of the electronic document(s) that will be exchanged via the electronic data interchange represented by the partner profile, customer profile, and communication setting(s). For example, in the context of an electronic data interchange between accounting systems, the sample electronic documents could comprise one or more purchase orders for the buyer's side of the interchange and one or more invoices for the seller's side of the interchange. The sample electronic document(s) can be generated using one or more predefined templates that are filled in with test data. These sample document(s) may be used to test the electronic data interchange and/or the integration process 160 that implements the electronic data interchange. In other words, a user may utilize the sample document(s) to fine-tune the configuration of the automatically generated electronic data interchange as needed (e.g., detect and correct errors in the automated generation).

By walking the user through the EDI onboarding process via a conversational session in first screen 150A and, in many cases, automatically collecting data via partner profile model 210, market profile model 220, and/or customer profile model 230, generation module 240 is able to quickly produce EDI output 152 in a single, fast, streamlined EDI onboarding process, which may take minutes or tens of minutes. This is in contrast to conventional EDI onboarding which can take weeks or months to complete. In particular, conventional EDI onboarding is performed manually by filling in numerous forms or questionnaires using information from many decentralized data sources, and in many cases, based on assumptions. These data sources may include the minds of numerous personnel who all have to be contacted in order to collect the necessary information. Accordingly, conventional EDI onboarding is costly, complex, and time-consuming, whereas disclosed embodiments are inexpensive, simple, and quick.

### 3. Example User Interface

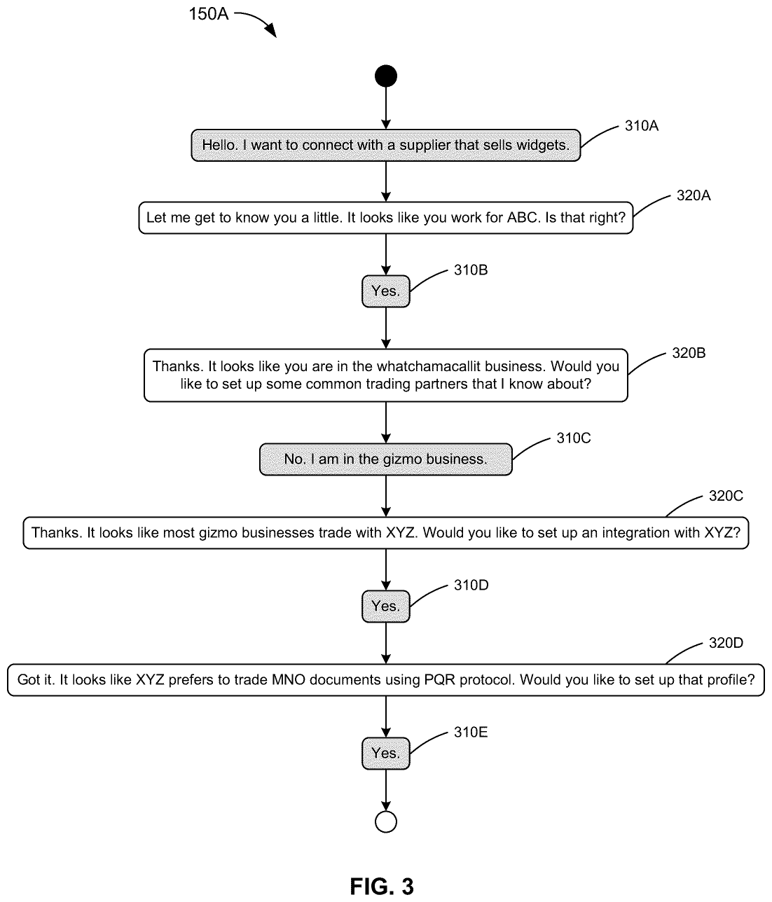

FIG. 3 illustrates an example first screen 150A of user interface 150 for EDI onboarding using artificial intelligence, according to an embodiment. To aid in understanding, an example conversational session is provided. In particular, generation module 240 may drive a conversation with a user to collect sufficient EDI data to generate EDI output 152. The conversation may comprise user inputs 310 to generation module 240 and server outputs 320 from generation module 240. Both the user inputs 310 and server outputs 320 may be expressed in natural language. As used herein, the term “natural language” refers to the language that would be expected from a conversation between humans. The EDI data may be collected from both the user and from AI model 114, which may comprise partner profile model 210, market profile model 220, and/or customer profile model 230.

Initially, the user may make a request in a user input 310A. In this example, the user has requested to be connected with a supplier of widgets. In response, server application 112 may ask the user to confirm the customer as company ABC in a server output 320A. The user may confirm the customer as company ABC in user input 310B. Since the user represents the customer, there may already be a customer profile for this customer stored in database 116 in association with the user's account. Thus, generation module 240 may retrieve the existing customer profile from database 116.

Next, generation module 240 may determine the market in which the customer is engaged. If the information already exists in database 116, the market may be retrieved from database 116. Otherwise, generation module 240 may query at least market profile model 220 for this information. For instance, market profile model 220 may be trained on corporate websites, including the corporate website of the customer. Thus, market profile model 220 may return the market in which the customer participates. In this case, market profile model 220 predicts that the customer engages in the whatchamacallit market, and generation module 240 seeks to confirm this prediction in server output 320B.

In this example, the user responds in user input 310C with a correction that the customer is engaged in the gizmo market, rather than the whatchamacallit market. Next, generation module 240 may utilize the customer's market to predict a trading partner. For example, generation module 240 may query at least partner profile model 210 and market profile model 220 to determine potential trading partners for a customer in the gizmo market. Partner profile model 210 may predict trading partners based on patterns in historical data 214 between other customers in the gizmo market and their trading partners. In addition, market profile model 220 may predict trading partners based on websites of other companies in the same market. Generation module 240 may aggregate this information (e.g., based on weightings applicable to partner profile model 210 and market profile model 220) to predict that company XYZ is a likely trading partner of the customer. Thus, generation module 240 seeks to confirm that the user would like to set up an integration with company XYZ in server output 320C.

The user confirms the integration with company XYZ in user input 310D. Next, generation module 240 may predict a partner profile for company XYZ. For example, generation module 240 may query at least partner profile model 210 to determine a potential partner profile for company XYZ. Partner profile model 210 may predict the partner profile based on partner profiles commonly used for company XYZ in historical data 214. The predicted partner profile may utilize the MNO standard and the PQR protocol. Thus, in server output 320D, generation module 240 seeks to confirm the document standard as the MNO standard and the communication protocol as the PQR protocol.

The user confirms the document standard and communication protocol with user input 310E. Thus, generation module 240 has the customer profile, the partner profile (e.g., document standard), and the communication settings (e.g., communication protocol), representing EDI output 152. In addition, generation module 240 may generate one or more sample electronic documents. Next, generation module 240 may redirect the user to a second screen 150B, in which the user may modify EDI output 152, incorporate EDI output 152 into a trading-partner element or other element of an integration process 160, and/or the like. This ends the conversational session between generation module 240 and the user.

### 4. Example Process

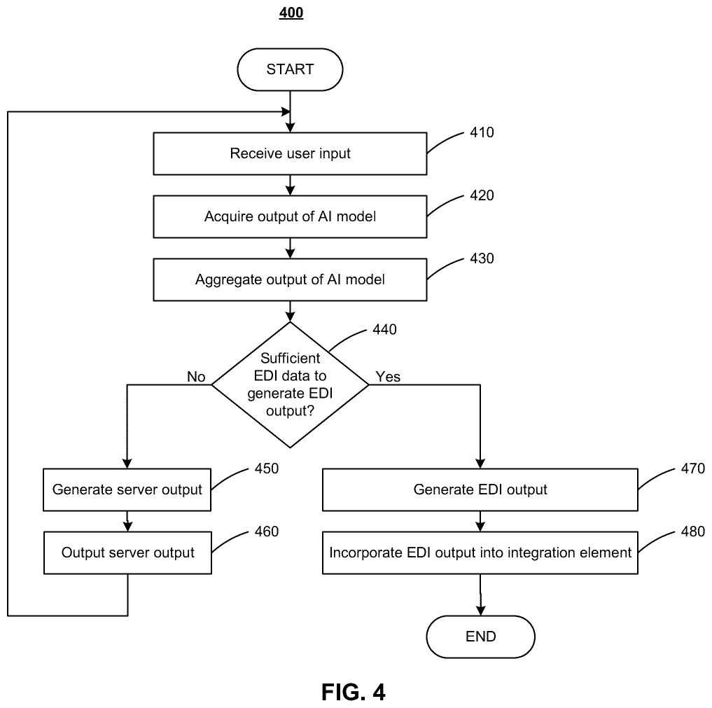

FIG. 4 illustrates an example EDI onboarding process 400 using artificial intelligence, according to an embodiment. Process 400 may be implemented by server application 112, and particularly, by generation module 240 of server application 112. Generation module 240 interacts with a user via user interface 150, as well as with AI model 114, which may comprise a plurality of models, including partner profile model 210, market profile model 220, and customer profile model 230. Process 400 may be performed for each conversational session between a user and generation module 240.

While process 400 is illustrated with a certain arrangement and ordering of subprocesses, process 400 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

In subprocess 410, a user input 310 is received. In particular, a user may input a question, request, statement, and/or the like into a chat interface in first screen 150A of user interface 150. User input 310 may be expressed in natural language.

In subprocess 420, the output of AI model 114 may be acquired, based on the user input 310 received in subprocess 410. In particular, generation module 240 may generate a query based on user input 310. For example, generation module 240 could comprise a generative AI model, such as one of the GPT series of large language models (e.g., GPT-4). Generation module 240 may generate a prompt, using one or more logical rules and/or templates, that requests the generative AI model to generate one or more queries to AI model 114 based on user input 310. The context of the generative AI model may be maintained throughout the entire conversational session represented by process 400. Generation module 240 may input the one or more queries to AI model 114, to acquire the responsive output of AI model 114. The output of AI model 114 may comprise the output of each of one or a plurality, including potentially all, of partner profile model 210, market profile model 220, and customer profile model 230. In subprocess 420, generation module 240 may input queries to each of the plurality of models in AI model 114 or just a relevant subset of the plurality of models in AI model 114. When the subset of models contains a plurality of models, the subset of models may be executed in parallel. For example, partner profile model 210, market profile model 220, and customer profile model 230 can all be executed simultaneously to provide parallel outputs to generation module 240.

In general, when collecting EDI data (e.g., establishing a partner profile or customer profile, communication setting(s), etc.), generation module 240 may run through a list of specific EDI onboarding questions to which answers are required. Generation module 240 may utilize the chat interface in first screen 150A and/or AI model 114 to determine the most likely answer to each EDI onboarding question. When determining an answer to a particular question, generation module 240 may either confirm the answer with the user via a server output 320 (e.g., if the confidence is relatively low, such as below a threshold) or assume that the answer is correct (e.g., if the confidence is relatively high, such as above a threshold). For example, generation module 240 may confirm a particular communication protocol with the user (e.g., PQR protocol in the above example). Having definitively established the communication protocol, generation module 240 may fill in other communication settings (e.g., port number) without consulting the user. This enables generation module 240 to spare the user from having to input or confirm every mundane or inconsequential detail. This, in turn, can significantly reduce the time and complexity of EDI onboarding. It should be understood that the user will have an opportunity to correct any of the confirmed or assumed data later (e.g., in second screen 150B), if necessary.

In subprocess 430, when there are a plurality of outputs from a plurality of models in the output of AI model 114, the outputs may be aggregated into a single output. Any suitable aggregation function may be used. In an embodiment, the aggregation function may weight the output of each of partner profile model 210, market profile model 220, and customer profile model 230, based on their relative reliabilities. For example, customer profile model 230 may be weighted higher than partner profile model 210, and partner profile model 210 may be weighted higher than market profile model 220. Each weighting may be combined (e.g., multiplied) with a confidence metric (e.g., that the respective model outputs) for the respective model's output. In an embodiment, the aggregation function selects the single output with the highest weighted confidence metric as the aggregated output. Alternatively, the aggregation function could merge the outputs in some manner. For instance, the aggregation function could generate a prompt, using one or more logical rules, from the outputs, and prompt the generative AI model of generation module 240 to compose a final aggregated output (i.e., in natural language).

In subprocess 440, it is determined whether or not the EDI data that have been collected up to the current iteration is sufficient to generate EDI output 152. It should be understood that there are sufficient EDI data when all of the data necessary to generate a partner profile, a customer profile, the required communication setting(s), and/or the sample electronic document(s) have been collected. In the case of the partner profile and customer profile, the necessary data may comprise the applicable document standard, the version number of the applicable document standard, configuration information, and/or the like. In the case of the communication setting(s), the necessary data may comprise a communication protocol, configuration information, and/or the like. After each iteration of subprocess 430, a state of the EDI data may be updated according to a state machine or other behavioral model. A final state in the behavioral model may be a state in which all of the necessary EDI data have been collected, and other states in the behavioral model may represent no collected EDI data and all possible permutations of partial subsets of collected EDI data. When there are insufficient EDI data to generate EDI output 152 (i.e., “No” in subprocess 440), process 400 proceeds to subprocess 450. Otherwise, when there are sufficient EDI data to generate EDI output 152 (i.e., “Yes” in subprocess 440), process 400 proceeds to subprocess 470.

In subprocess 450, a server output 320 is generated. Server output 320 may be generated based on the aggregated output from subprocess 430. If a generative AI model is used to produce the aggregated output, server output 320 may comprise or consist of the aggregated output. Alternatively, server output 320 may be derived from the aggregated output using one or more logical rules, and/or using the generative AI model to generate server output 320 based on the aggregated output (e.g., by inputting a prompt comprising the aggregated output to the generative AI model).

In subprocess 460, server output 320 is output. In particular, server output 320 may be displayed in the chat interface in first screen 150A of user interface 150. Server output 320 may comprise a question, request, statement, and/or the like, expressed in natural language.

In subprocess 470, EDI output 152 is generated from the EDI data, which were collected during the conversational session through one or more iterations of subprocesses 410-460. As discussed elsewhere herein, EDI output 152 may comprise one or more of a partner profile, customer profile, communication setting(s), and/or sample electronic document(s).

In subprocess 480, EDI output 152 may be incorporated into an element of an integration process 160. In particular, user interface 150 may redirect from first screen 150A to second screen 150B, in which the user may construct and/or configure the element, construct an integration process 160 that includes the element, deploy the constructed integration process 160, and/or the like.

As an example, the element may be a trading-partner element that utilizes the customer profile and partner profile to define the two ends of the electronic data interchange. In addition, each of the customer profile and the partner profile may be configured according to the communication setting(s). If the communication setting(s) for the customer profile and the partner profile are different, the respective communication setting(s) may be embedded within the respective profile. Otherwise, if the communication setting(s) for the customer profile and the partner profile are the same, both profiles may be associated with shared communication setting(s).

### 5. Example Embodiment

Disclosed embodiments, including architecture 200 and process 400, may be integrated into a platform 110 for managing integration processes 160 in one or more integration platforms within integration environment 140. Relative to conventional EDI onboarding, the disclosed embodiments may reduce the time and costs of EDI onboarding, increase accuracy and consistency of the resulting integration elements, and/or enable testing using automatically generated sample electronic documents.

In particular, a user may converse, via a chat interface in first screen 150A of user interface 150, generated by server application 112, with a generation module 240 of server application 112. Generation module 240 utilizes user inputs 310 and the output of AI model 114 to collect sufficient EDI data to generate EDI output 152. EDI output 152 may then be used to construct a trading-partner element that can be incorporated into one or more integration processes 160. EDI output 152 and the trading-partner element may comprise a partner profile, customer profile, and one or more communication setting(s). If needed, the user may customize the configuration of the trading-partner element to suit the particular needs of the organization by which it will be used, as well as to correct any deficiencies or misconfigurations produced in EDI output 152. Thus, EDI output 152 does not have to be perfectly generated by generation module 240 in the first instance. The user may also test the trading-partner element or integration process 160 using one or more sample electronic documents (e.g., included in EDI output 152). When executed, the trading-partner element may establish a connection between a customer system (e.g., a third-party system 170, or a software application within integration environment 140) and a partner system (e.g., a third-party system 170, or a software application within integration environment 140), according to the communication setting(s), and transfer one or more electronic documents over the connection between the two systems (e.g., from the customer system to the partner system and/or from the partner system to the customer system).

In an embodiment, historical data 214 and/or customer data 234 may be derived from database 116 of an iPaaS platform. In this case, partner profile model 210 and/or customer profile model 230 may be trained and retrained on a large and ever-growing history of profiles, transactions, and metadata from an iPaaS platform. Importantly, the model(s) can see both sides of the transactions, which provides insight on which types of customers trade with which types of trading partners and vice versa, how both sides of the transactions are configured, and/or the like. This can enable AI model 114 to recommend trading partners and/or configurations to a customer, based on the similarities of the customer with other customers who have implemented electronic data interchange with those trading partners and/or using those configurations.

This also enables AI model 114 to recommend new trading partners to a customer. For example, a user may request generation module 240, in a user input 310 via the chat interface of first screen 150A, to recommend one or more trading partners. In response, generation module 240 may query at least partner profile model 210 based on the user's query, to predict one or more trading partners that are relevant to the customer. The predicted trading partner(s) may then be provided by generation module 240 as recommendation(s) to the user in a server output 320 via the chat interface. In addition, generation module 240 may prompt the user to confirm that the user would like generation module 240 to onboard these trading partner(s). In response to the confirmation, generation module 240 may walk the user through the steps necessary to collect all of the EDI data needed to generate EDI output 152 for the trading partner(s). Thus, users can utilize generation module 240 to discover and set up electronic data interchange with new trading partners.

In an embodiment, generation module 240 may also provide other functions. For example, generation module 240 could provide real-time monitoring and alerting of issues during EDI onboarding. For instance, generation module 240 or AI model 114 may detect invalid values within the collected EDI data (e.g., the provided phone number is in the wrong country, as detected, for example, by market profile model 220), and correct this information (e.g., automatically using AI model 114 and/or by prompting the user). As another example, generation module 240 or AI model 114 could provide real-time vendor risk analysis (e.g., a particular trading partner is unreliable, as detected, for example, by partner profile model 210).

### 6. Example Processing System

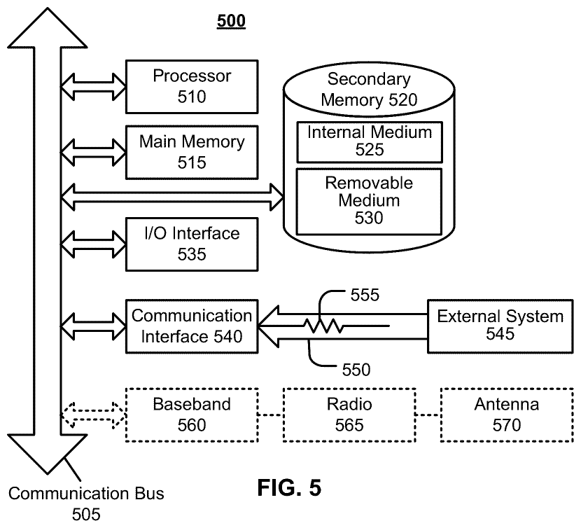

FIG. 5 illustrates an example processing system, by which one or more of the processes described herein may be executed, according to an embodiment. For example, system 500 may be used to store and/or execute software that implements architecture 200 and/or process 400, and/or may represent components of platform 110, user system(s) 130, and/or other processing devices described herein. System 500 can be any processor-enabled device (e.g., server, personal computer, etc.) that is capable of wired or wireless data communication. Other processing systems and/or architectures may also be used, as will be clear to those skilled in the art.

System 500 may comprise one or more processors 510. Processor(s) 510 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 510. Examples of processors which may be used with system 500 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 510 may be connected to a communication bus 505. Communication bus 505 may include a data channel for facilitating information transfer between storage and other peripheral components of system 500. Furthermore, communication bus 505 may provide a set of signals used for communication with processor 510, including a data bus, address bus, and/or control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 500 may comprise main memory 515. Main memory 515 provides storage of instructions and data for programs executing on processor 510, such as any of the software discussed herein. It should be understood that programs stored in the memory and executed by processor 510 may be written and/or compiled according to any suitable language, including without limitation C/C++, Java, JavaScript, Perl, Python, Visual Basic, NET, and the like. Main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 500 may comprise secondary memory 520. Secondary memory 520 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 500. The computer software stored on secondary memory 520 is read into main memory 515 for execution by processor 510. Secondary memory 520 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 520 may include an internal medium 525 and/or a removable medium 530. Internal medium 525 and removable medium 530 are read from and/or written to in any well-known manner. Internal medium 525 may comprise one or more hard disk drives, solid state drives, and/or the like. Removable storage medium 530 may be, for example, a magnetic tape drive, a compact disc (CD) drive, a digital versatile disc (DVD) drive, other optical drive, a flash memory drive, and/or the like.

System 500 may comprise an input/output (I/O) interface 535. I/O interface 535 provides an interface between one or more components of system 500 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 500 may comprise a communication interface 540. Communication interface 540 allows software to be transferred between system 500 and external devices, networks, or other information sources. For example, computer-executable code and/or data may be transferred to system 500 from a network server via communication interface 540. Examples of communication interface 540 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 500 with a network (e.g., network(s) 120) or another computing device. Communication interface 540 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 540 is generally in the form of electrical communication signals 555. These signals 555 may be provided to communication interface 540 via a communication channel 550 between communication interface 540 and an external system 545. In an embodiment, communication channel 550 may be a wired or wireless network (e.g., network(s) 120), or any variety of other communication links. Communication channel 550 carries signals 555 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 515 and/or secondary memory 520. Computer-executable code can also be received from an external system 545 via communication interface 540 and stored in main memory 515 and/or secondary memory 520. Such computer-executable code, when executed, enables system 500 to perform the various functions of the disclosed embodiments as described elsewhere herein.

In an embodiment that is implemented using software, the software may be stored on a computer-readable medium and initially loaded into system 500 by way of removable medium 530, I/O interface 535, or communication interface 540. In such an embodiment, the software is loaded into system 500 in the form of electrical communication signals 555. The software, when executed by processor 510, preferably causes processor 510 to perform one or more of the processes and functions described elsewhere herein.

System 500 may optionally comprise wireless communication components that facilitate wireless communication over a voice network and/or a data network (e.g., in the case of user system 130). The wireless communication components comprise an antenna system 570, a radio system 565, and a baseband system 560. In system 500, radio frequency (RF) signals are transmitted and received over the air by antenna system 570 under the management of radio system 565.

In an embodiment, antenna system 570 may comprise one or more antennae and one or more multiplexors (not shown) that perform a switching function to provide antenna system 570 with transmit and receive signal paths. In the receive path, received RF signals can be coupled from a multiplexor to a low noise amplifier (not shown) that amplifies the received RF signal and sends the amplified signal to radio system 565.

In an alternative embodiment, radio system 565 may comprise one or more radios that are configured to communicate over various frequencies. In an embodiment, radio system 565 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 565 to baseband system 560.

If the received signal contains audio information, then baseband system 560 decodes the signal and converts it to an analog signal. Then the signal is amplified and sent to a speaker. Baseband system 560 also receives analog audio signals from a microphone. These analog audio signals are converted to digital signals and encoded by baseband system 560. Baseband system 560 also encodes the digital signals for transmission and generates a baseband transmit audio signal that is routed to the modulator portion of radio system 565. The modulator mixes the baseband transmit audio signal with an RF carrier signal, generating an RF transmit signal that is routed to antenna system 570 and may pass through a power amplifier (not shown). The power amplifier amplifies the RF transmit signal and routes it to antenna system 570, where the signal is switched to the antenna port for transmission.

Baseband system 560 is communicatively coupled with processor(s) 510, which have access to memory 515 and 520. Thus, software can be received from baseband processor 560 and stored in main memory 510 or in secondary memory 520, or executed upon receipt. Such software, when executed, can enable system 500 to perform the various functions of the disclosed embodiments.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, in each of one or more iterations of a conversational session,
receive a user input;
acquire an output from each of a plurality of models;
aggregate the outputs of the plurality of models into electronic data interchange (EDI) data;
determine whether or not the EDI data are sufficient to generate an EDI output, wherein the EDI output comprises a partner profile, a customer profile, and one or more communication settings;
when the EDI data are not sufficient, generate and output a prompt, and extend the conversational session with another iteration; and
when the EDI data are sufficient, generate the EDI output.

2. The method of claim 1, wherein the EDI output further comprises one or more sample electronic documents to be exchanged via electronic data interchange.

3. The method of claim 1, further comprising using the at least one hardware processor to, after generating the EDI output, generate an element within an integration process based on the partner profile, the customer profile, and the one or more communication settings, wherein the element comprises one or more software modules.

4. The method of claim 3, further comprising using the at least one hardware processor to deploy the integration process within an integration environment.

5. The method of claim 3, wherein the element retrieves electronic documents from a partner system using the partner profile and the one or more communication settings.

6. The method of claim 3, wherein the element sends electronic documents to a partner system using the partner profile and the one or more communication settings.

7. The method of claim 1, wherein each of the partner profile and the customer profile comprises a document standard.

8. The method of claim 1, wherein the one or more communication settings comprise a communication protocol.

9. The method of claim 1, wherein the plurality of models comprises a partner profile model that is trained using historical data acquired from one or more integration platforms in an integration environment.

10. The method of claim 9, wherein the historical data comprise customer and partner profiles implemented in the one or more integration platforms and EDI transactions that have occurred in the one or more integration platforms.

11. The method of claim 10, wherein the integration environment is an integration platform as a service (iPaaS) platform.

12. The method of claim 9, wherein the partner profile model comprises an artificial neural network.

13. The method of claim 9, wherein the partner profile model is trained to predict one or more output features, each representing a parameter of the partner profile, based on one or more input features.

14. The method of claim 1, wherein the plurality of models comprises a market profile model that is trained on unstructured data.

15. The method of claim 14, wherein the unstructured data comprise websites.

16. The method of claim 14, wherein the market profile model comprises a large language model.

17. The method of claim 1, wherein the plurality of models comprises a customer profile model that is trained using one or both of structured or semi-structured data.

18. The method of claim 17, wherein the structured or semi-structured data comprise electronic documents.

19. A system comprising:
at least one hardware processor; and
software that is configured to, when executed by the at least one hardware processor, in each of one or more iterations of a conversational session,
receive a user input,
acquire an output from each of a plurality of models,
aggregate the outputs of the plurality of models into electronic data interchange (EDI) data,
determine whether or not the EDI data are sufficient to generate an EDI output, wherein the EDI output comprises a partner profile, a customer profile, and one or more communication settings,
when the EDI data are not sufficient, generate and output a prompt, and extend the conversational session with another iteration, and
when the EDI data are sufficient, generate the EDI output.

20. A non-transitory computer-readable medium having instructions stored therein, wherein the instructions, when executed by a processor, cause the processor to, in each of one or more iterations of a conversational session,
receive a user input;
acquire an output from each of a plurality of models;
aggregate the outputs of the plurality of models into electronic data interchange (EDI) data;
determine whether or not the EDI data are sufficient to generate an EDI output, wherein the EDI output comprises a partner profile, a customer profile, and one or more communication settings;
when the EDI data are not sufficient, generate and output a prompt, and extend the conversational session with another iteration; and
when the EDI data are sufficient, generate the EDI output.
